(19) United States
(12) Patent Application Publication
(10) Pub. No.: US 2020/0121541 A1
(43) Pub. Date: Apr. 23, 2020

(54) HAND ASSIST ORTHOTIC

(71) Applicant: Abilitech Medical, Inc., Minneapolis, MN (US)

(72) Inventors: Rob Wudlick, Excelsior, MN (US); Eli Krumholz, Minneapolis, MN (US); James Rohl, Prescott, WI (US); Joe Schachtner, St. Paul, MN (US); Brett Neubauer, Eagan, MN (US); Angie Conley, Minneapolis, MN (US); Mark Oreschnick, Inver Grove Heights, MN (US); Shawna Persaud, Apple Valley, MN (US); Keddy Conocchioli, Austin, TX (US); Travis Yoch, Woodbury, MN (US); Chris Narveson, Minneapolis, MN (US); Rob Roberts, St. Paul, MN (US)

(21) Appl. No.: 16/659,800

(22) Filed: Oct. 22, 2019

Related U.S. Application Data
(60) Provisional application No. 62/748,583, filed on Oct. 22, 2018.

(51) Int. Cl. A61H 1/02

(52) U.S. Cl. CPC A61H 1/0288; A61H 2201/1635; A61H 2201/165; A61H 2201/169; A61H 2201/5097; A61H 2201/1647; A61H 2201/5048; A61H 2201/5064; A61H 2201/14

(57) ABSTRACT

A hand orthotic configured to provide torque assistance with multiple degrees of freedom, including the flexion of the pinky, ring, middle, and index fingers, as well as providing torque assistance for the flexion and abduction of the thumb. The hand orthotic including a hand interface, a control module including at least a first driver and a second driver, and a plurality of cables including at least a first cable operably coupling the first driver to a thumb portion of the hand interface and a second cable operably coupling the second driver to the thumb portion of the hand interface, wherein the first drivers configured to provide an augmented abduction motion to the thumb portion and the second drivers configured to provide an augmented flexion motion to the thumb portion.

### RELATED APPLICATION INFORMATION

This application claims the benefit of U.S. Provisional Application No. 62/748,583, filed Oct. 22, 2018, the contents of which are fully incorporated herein by reference.

### TECHNICAL FIELD

The present disclosure relates generally to systems and methods for hand assist in a patient suffering from a loss of motor skills, and more particularly to a cable operated hand orthotic and method of use configured to augment hand movement and serve as an aid in improving the overall motor skills in patients suffering from neuromuscular disorders, spinal injuries and/or motor impairment.

### BACKGROUND

Individuals with neuromuscular abnormalities, such as neuromuscular disorders, spinal injuries, or impairment of limbs as a result of a stroke, often experience muscular atrophy and/or impaired motor function, which can lead to a partial or full loss of functionality in their limbs and upper body. Such a loss in functionality can make the performance of routine tasks difficult, thereby adversely affecting the individual's quality of life.

In the United States alone, 1.4 million people suffer from neuromuscular disorders. It is estimated that approximately 45,000 of these people are children, who are affected by one or more pediatric neuromuscular disorders. Pediatric neuromuscular disorders include spinal muscular atrophy (SMA), cerebral palsy, arthrogryposis multiplex congenital (AMC), Becker muscular dystrophy, and Duchenne muscular dystrophy (DMD). Adult neuromuscular diseases include multiple sclerosis (MS), amyotrophic lateral sclerosis (ALS) and facioscapulohumeral muscular dystrophy (FSHD). Many of these muscular disorders are progressive, such that there is a slow degeneration of the spinal cord and/or brainstem motor neurons resulting in generalized weakness, atrophy of skeletal muscles, and/or hypotonia.

In the United States, approximately 285,000 people suffer from spinal cord injuries, with 17,000 new cases added each year. Approximately 54% of spinal cord injuries are cervical injuries, resulting in upper extremity neuromuscular motor impairment. Spinal cord injuries can cause morbid chronic conditions, such as lack of voluntary movement, problematic spasticity, and other physical impairments which can result in a lower quality of life and lack of independence.

In the United States, it is estimated that there are over 650,000 new surviving stroke victims each year. Approximately 70-80% of stroke victims have upper limb impairment and/or hemiparesis. Numerous other individuals fall victim to silent cerebral infarctions (SCI), or “silent strokes,” which can also lead to progressive limb impairment. Complications from limb impairment and hemiparesis may involve spasticity, or the involuntary contraction of muscles when an individual tries to move their limb. If left untreated, the spasticity can result in the muscles freezing in abnormal and painful positions. Also, following a stroke, there is an increased possibility of developing hypertonicity, or the increased tightness of muscle tone.

People afflicted with neuromuscular abnormalities often exhibit diminished fine and gross motor skills. In cases where a person is capable of only asymmetric control of a particular joint, the person may be able to control the muscle group responsible for flexion about the joint, but his or her control over the muscle group responsible for extension may be impaired. Similarly, the opposite may be true, in that the user may have control in the extension direction, but not in the flexion direction. In either case, the person may be unlikely to perform the task they desire. Even in cases where a person retains symmetric control over a joint, the person may be left with reduced control over muscle groups on opposite sides of the joint. As a result, the person may be incapable of achieving the full range of motion that the joint would normally permit and/or be incapable of controlling the joint so that the associated finger or limb segments exert the amount of force required to perform the desired task.

In many cases, a reduction in strength or impairment of motor function, as a result of neuromuscular abnormalities, can be slowed, stopped, or even reversed through active treatment and therapy. At least for stroke victims, data suggests that the sooner that the therapy is started after the impaired motor function is first noticed, and the greater the amount of therapy that is performed by the patient, the more likely the patient is to have a better recovery. Unfortunately, the therapy often uses expensive equipment and is limited to in-clinic settings, thereby significantly restricting the amount of therapy that can be performed by the patient.

In other cases, such as with progressive neuromuscular disorders, the goal of the treatment may be to slow the decline in functionality, so as to maintain the individual's quality of life for as long as possible. Common treatment methods include physical therapy combined with medications to provide symptomatic relief. Regarding spinal cord injuries, while there are no known treatments that can reverse morbidities, repetitive high-intensity exercise and the use of orthoses have been used to improve the strength and overall neuromuscular health of patients. Over the years, a number of upper arm support devices have been developed to strengthen upper extremities and improve independence for accomplishing activities of daily living (ADLs) in individuals with neuromuscular abnormalities. Examples of such orthoses are disclosed in Published PCT Application Nos. WO2018111853 and WO2018165413 (assigned to the Applicant of the present disclosure), the contents of which are hereby incorporated by reference herein. Although these orthotics have been proven to work exceptionally well, they are primarily aimed at counteracting the weight of gravity in the arm of a user, rather than addressing hand function. Orthotics for assisting hand function and supporting rehabilitation have not progressed as rapidly as orthotics for upper or lower limbs, partially due to the increased motor and sensory function required for effective use of hands. Accordingly, few options exist for patients in need of a powered hand orthotic.

One commercially available hand orthotic is referred to as the Bioserve SEM™ Glove, which is an actuated cable driven glove that enables an augmented three finger grasp. Unfortunately, with this type of glove, the augmented force is proportional to the force applied by the user; accordingly, the user needs to have some hand functionality in order to use the glove. Another commercially available orthotic is the Myomo® Powered Grasp, which is powered by an electronic actuator dependent on electromyography (EMG) produced by skeletal muscles of the arm, and therefore cannot be used as a hand only device. Accordingly, there remains a need for a commercially available powered hand configured to either function as a standalone hand assist device or be integrated into a comprehensive mobile, upper limb orthotic.

The present disclosure addresses this concern.

### SUMMARY OF THE DISCLOSURE

Embodiments of the present disclosure provide a powered hand orthotic configured to provide torque assistance with three degrees of freedom in the flexion/extension of the pinky, ring, middle, and index fingers, and both flexion/extension and abduction/adduction of the thumb. Embodiments of the present disclosure further provide a user friendly control system, a gearbox isolation lock configured to isolate portions of the orthotic from high force loads during operational use, and a two-part clamshell design of finger interfaces configured to aid in donning and doffing of the hand orthotic.

One embodiment of the present disclosure provides a hand orthotic including a hand interface, a control module, and a plurality of cables. The hand interface can be operably coupleable to a hand of a user, and can include a thumb interface formed of a resilient material. The control module can be operably coupled to a forearm of the user, and can include at least a first driver and a second driver. The plurality of cables can operably couple the hand interface to the control module, and can include at least a first cable operably coupling the first driver to a portion of the thumb interface and a second cable operably coupling the second driver to a portion of the thumb interface, wherein the first driver is configured to provide augmented abduction motion to the thumb interface and the second driver is configured to provide an augmented flexion motion to the thumb interface.

In one embodiment, the resilient material of the thumb interface naturally biases the thumb interface against a first tensile force and a second tensile force provided by the respective first and second cables toward a neutral position. In one embodiment, the resilient material of the thumb interface is constructed of a thermoplastic elastomer. In one embodiment, the thumb interface further includes at least one resilient stiffening member configured to bias the thumb interface against at least one of the first tensile force or the second tensile force toward the neutral position.

In one embodiment, the thumb interface includes a sleeve portion configured to at least partially fit over a thumb of the user, and a metacarpal extension portion operably coupled to the sleeve portion and configured to reside in proximity to a metacarpal bone of a user. In one embodiment, the sleeve portion further includes structure defining a first cutout in proximity to a distal interphalangeal joint of a user and a second cutout in proximity to a proximal interphalangeal joint of a user, thereby promoting ease in bending at the sleeve in proximity to the first and second cutout.

In one embodiment, the hand interface can include a plurality of finger interfaces. In one embodiment, the hand interface is customizable to meet the size and assistance needs of a user. In one embodiment, the thumb interface includes a top portion and a bottom portion configured to selectively couple to one another during donning and doffing of the hand interface.

Another embodiment of the present disclosure provides a hand orthotic including a hand interface and a control module. The control module can include a plurality of motors and corresponding gearboxes operably coupled to the hand interface via a plurality of cables. The control module can further include a gearbox isolation lock configured to selectively shift between a rotation position enabling rotation of the respective plurality of motors and corresponding gearboxes, and a lockout position configured to at least partially isolate the plurality of motors and corresponding gearboxes from loads experienced by the plurality of cables during operational use.

Another embodiment of the present disclosure provides a method of controlling a hand orthotic including: receiving a hand interface pre-shaping command; controlling a plurality of drivers to drive individual finger interfaces of a hand interface to predetermined positions according to the pre-shaping command; and activating a head worn orientation sensor to receive one or more grip commands.

The summary above is not intended to describe each illustrated embodiment or every implementation of the present disclosure. The figures and the detailed description that follow more particularly exemplify these embodiments.

### BRIEF DESCRIPTION OF THE DRAWINGS

The disclosure can be more completely understood in consideration of the following detailed description of various embodiments of the disclosure, in connection with the accompanying drawings, in which:

FIG. 1 is a perspective view depicting a powered hand orthotic system, in accordance with an embodiment of the disclosure.

FIG. 2A is a top plan view depicting a portion of a hand interface, in accordance with a first embodiment of the disclosure.

FIG. 2B is a bottom plan view depicting the portion of the hand interface of FIG. 2A.

FIG. 3 is a perspective view depicting a finger interface, in accordance with an embodiment of the disclosure.

FIG. 4A is a top perspective view depicting a hand interface, in accordance with an embodiment of the disclosure.

FIG. 4B is a bottom perspective view depicting the hand interface of FIG. 4A.

FIG. 5 is a perspective view depicting a portion of a hand interface, in accordance with a second embodiment of the disclosure.

FIG. 6A is a profile view depicting a portion of a hand interface, in accordance with a third embodiment of the disclosure.

FIG. 6B is a top plan view depicting the portion of the hand interface of FIG. 6A.

FIG. 7 is a partial, perspective view of a clamshell design for a finger interface, in accordance with an embodiment of the disclosure.

FIG. 8 is a perspective view depicting a hand interface docking station to serve as an aid in donning and doffing a hand interface, in accordance with an embodiment of the disclosure.

FIG. 9A is a system architecture diagram depicting a control module, in accordance with an embodiment of the disclosure.

FIG. 9B is a close-up architecture diagram depicting an individual motor, gearbox and rotary encoder of the control module of FIG. 9A.

FIG. 10 is a perspective view depicting a control module, in accordance with an embodiment of the disclosure.

FIG. 11A is a profile view depicting the control module of FIG. 10 in a free rotation position, in accordance with an embodiment of the disclosure.

FIG. 11B is a profile view depicting the control module of FIG. 10 in a lockout position, in accordance with an embodiment of the disclosure.

FIGS. 12A-B are diagrams depicting prospective lift, wrist flexion torque and reactive forces between a human hand and a rigid bar.

FIG. 13A is a profile view depicting a palm interface configured to enable wrist flexion, in accordance with an embodiment of the disclosure.

FIG. 13B is a top, plan view depicting the palm interface of FIG. 13A.

FIG. 14 is a flowchart depicting a method of controlling of a hand orthotic, in accordance with an embodiment of the disclosure.

While embodiments of the disclosure are amenable to various modifications and alternative forms, specifics thereof shown by way of example in the drawings will be described in detail. It should be understood, however, that the intention is not to limit the disclosure to the particular embodiments described. On the contrary, the intention is to cover all modifications, equivalents, and alternatives falling within the spirit and scope of the subject matter as defined by the claims.

### DETAILED DESCRIPTION

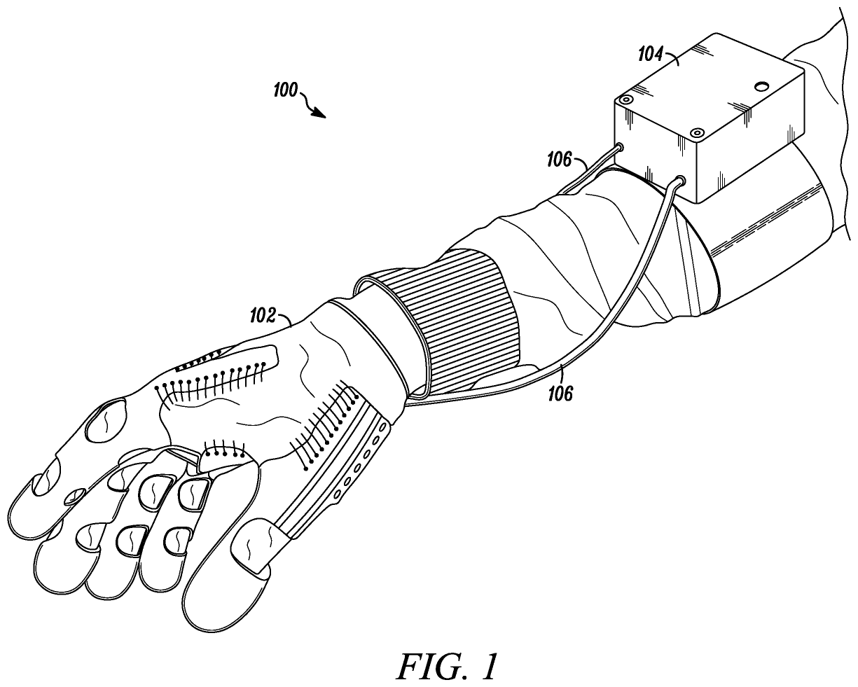

Referring to FIG. 1, a powered hand orthotic system 100 is depicted in accordance with an embodiment of the disclosure. In some embodiments, the hand orthotic 100 is configured to provide flexion (or extension) augmentation to the index, middle, ring, and pinky fingers, and both flexion (or extension) and abduction (or adduction) augmentation to the thumb. As depicted, the hand orthotic 100 can include a hand interface 102 and a control module 104. The hand interface 102 can be configured to be worn like a glove over portions of a hand of a user. The control module 104, which can include one or more motors/actuators and related electrical circuitry to power the hand interface 102, can be secured to a forearm of the user. Alternatively, the control module 104 can be coupled to a torso or other limb of the user (e.g., worn in a backpack, etc.). One or more cables 106 can operably couple the hand interface 102 to the control module 104.

It is to be appreciated that the term “user” or “patient” refers to any individual wearing or using any of the example embodiments described herein or alternative combinations thereof, whether human, animal, or inanimate. Additionally, it is to be appreciated that the terms “top” and “bottom,” particularly with reference to the hand interface, refer to respective portions of the hand interface configured to be positioned in proximity to a top or backside of a user's hand and a bottom or palm side of a user's hand, regardless of whether the orthotic 100 described herein is aligned with a gravitational frame of reference.

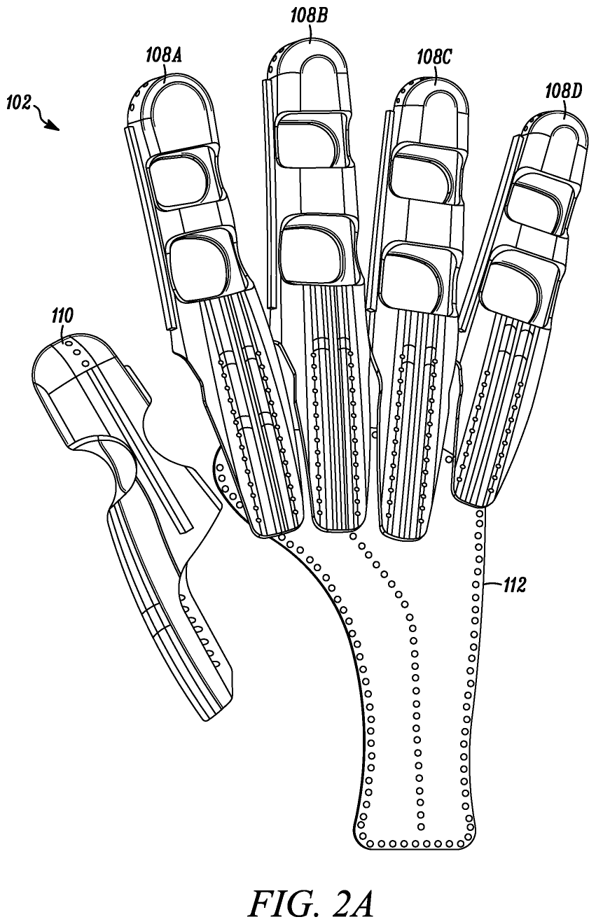

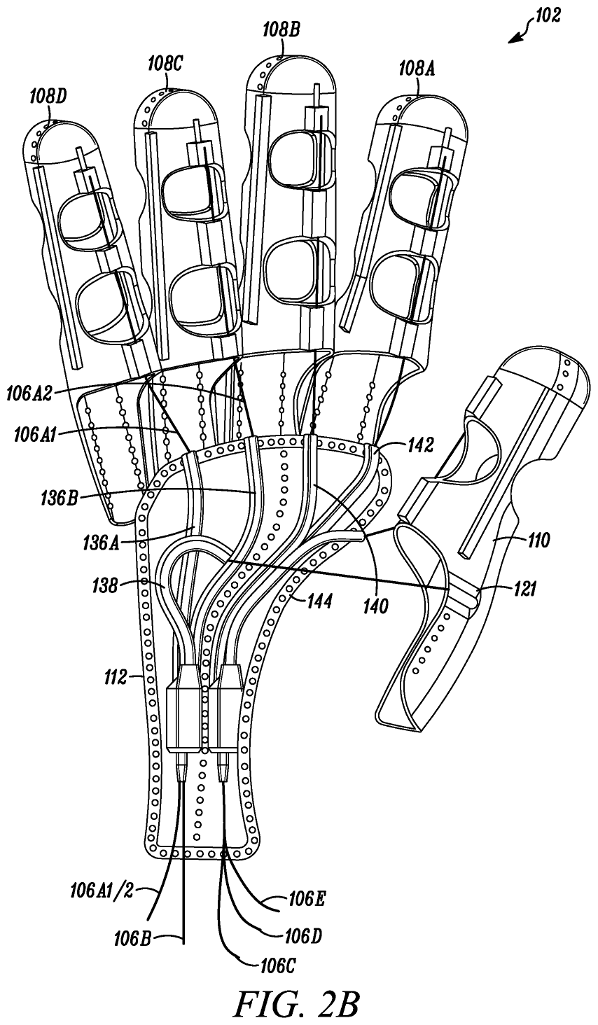

Referring to FIGS. 2A-B, top and bottom views of a hand interface 102 are depicted in accordance with a first embodiment of the disclosure. As depicted, the hand interface 102 can optionally include an index finger interface 108A, middle finger interface 108B, ring finger interface 108C, pinky finger interface 108D, thumb interface 110, and palm interface 112. Embodiments of the hand interface 102 can be modular in nature, such that the hand interface 102 is fully customizable to meet the size and assistance needs of any given user. For example, the size of each of the finger and palm interfaces 108A-D, 110 and 112 may be selected to fit a particular user. Further, each of the finger and palm interfaces 108A-D, 110 and 112 may optionally be omitted from the final hand interface 102 construction, based on the assistance needs and/or requirements of the user.

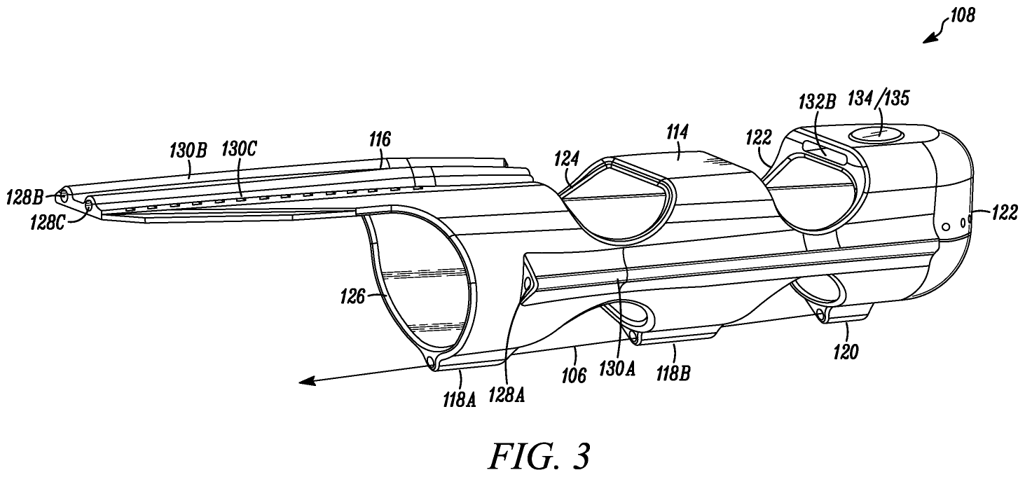

With additional reference to FIG. 3, each finger interface 108 can generally include a sleeve portion 114 with an optional metacarpal extension portion 116. A cable 106 (operably coupled to the control module 104) can traverse through one or more conduits 118A-B to an anchor 120 located in proximity to a distal end 122 of the finger interface 108. Thus, in some embodiments, the cable 106 can be routed along either the bottom or top of the finger, thereby enabling a linear force generated by the control module 104 to be converted into a rotary torque through the use of the finger interface 108, in combination with the anatomical structure of a finger of the user. Accordingly, embodiments of the present disclosure can rely on natural joints within a hand of the user during flexion/extension and/or abduction assistance, while shielding the skin of the patient from abrasion during movement of the cable 106. The specific bending locations of the finger interface 108 can be controlled by removing material on the respective top and bottom of the distal interphalangeal joint 122, the respective top and bottom of the proximal interphalangeal joint 124, and optionally the bottom of the metacarpophalangeal joint 126, for example via apertures or material cutouts.

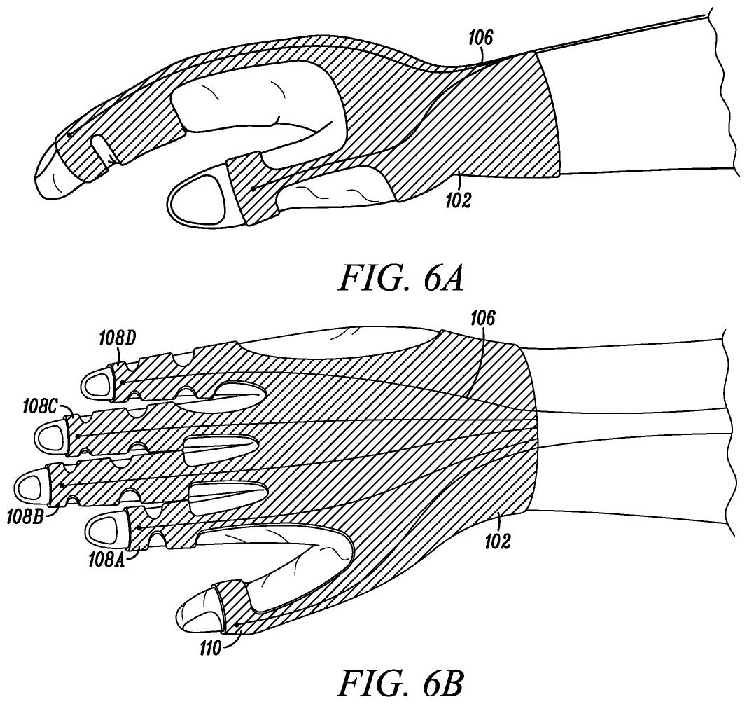

In some embodiments, the sleeve portion 114 can wrap around a tip of a finger of the user, thereby inhibiting a sliding of the finger interface 108 relative to the finger of the user during flexion/extension and/or abduction/adduction. In other embodiments, the sleeve 114 can be configured to expose the fingertip of the user (as depicted in FIGS. 6A-B), which can be beneficial to users with feeling and/or pressure sensation present in their fingertips. In some embodiments, portions of the hand interface 102 can be constructed of a lightweight, resilient material, such as a thermoplastic elastomer (TPE), which can be applied through fused deposition modeling (FTM) printing. In some embodiments, the material can have a shore hardness of about 85 A and a tensile strength of about 30.2 MPa. In some embodiments, the grip strength can further be improved by fabricating and/or coating the contact surfaces of the finger interface 108 out of one or more compliant materials with a high coefficient of friction, such as neoprene/nitrile blend, configured to enhance grip in wet or oily situations, while also being safe for users with latex allergies.

A natural resiliency of the construction material can retain a sufficient amount of mechanical energy to generally bias the finger interface 108 to a neutral or extended position (as depicted in FIG. 3). The biasing force of the finger interface 108 can be adjusted by removal of material from the distal interphalangeal 122, proximal interphalangeal 124 and metacarpophalangeal 126 joints. Biasing the hand interface 102 to an extended or otherwise neutral position can serve to counteract the effect of the force transmitted through the cable 106, thereby returning the finger interface 108 to the extended position, as well as to generally dampen spasticity which may be present in the user. In other embodiments, the biasing force can be configured to generally bias the finger interface 108 to a contracted, grip position.

The biasing force of the stiffening members 128A-C can be selected to meet the needs of the user. If an additional biasing force is desired, one or more resilient stiffening members or springs 128A-C can be added to a surface of the finger interface 108. For example, as depicted, one or more stiffening members 128A can be received within a compartment 130A located on one or both sides of the finger interface 108. Additionally, one or more stiffening members 128B/C can be received within a pair of compartment 130B/C located on the metacarpal extension 116. In some embodiments, the one or more stiffening members 128A-C can be in the form of nitinol rods, which can combine memory effect properties, with a high degree of elasticity and a high damping capability. In other embodiments, the hand interface 102 can include one or more thermoplastic elastomer (TPE) springs position within the distal interphalangeal 122, proximal interphalangeal 124 and metacarpophalangeal 126 cutout areas.

In some embodiments, the finger interface 108 can include a cavity 132 configured to house a sensor 134 and/or magnet 135. In some embodiments, the sensor 134 can be a force sensor, configured to provide haptic or visual feedback to the patient via one or more vibration motors, lights or LEDs positioned on the hand orthotic 100. For example, in one embodiment, the haptic feedback can be provided to the fingertips, back of the user's hand, or other area on the user with tactile sensation. In some embodiments, the sensor 134 can be an RFID sensor configured to sense a corresponding RFID tag in a daily use item, which can in turn communicate with the control module 104 for automatic adjustment of the hand interface 102. In yet another embodiment, the sensor 134 can be a camera configured to provide a visual detection/feedback of an applied grip strength (e.g., via deformation of the object being manipulated). In embodiments with a magnet 135, a magnetic attachment can be included in daily use items (e.g., eating utensils, a toothbrush, hair combs, etc.), which can magnetically locked into place via the magnet 135 to assist with activities of daily living.

With continued reference to FIGS. 2A-B, the thumb interface 110 can include features similar to that of the described finger interface 108, with an additional anchor 121 to mount the cable for abduction control. In one embodiment, the hand orthotic 100 can include five primary cables 106A-E to transmit force to the various finger interfaces 108A-D, 110. For example, in one embodiment, the cables 106 can be constructed of ultra-high molecular weight polyurethane (UHMW PE) Bowden cable with a rated tensile strength of 100 pounds and a fully compressed diameter of about 0.024 inches (0.06 mm). The use of such cables 106 enables a linear force (e.g., via an actuator or motor) to be easily transmitted around complicated geometries in a compact form. In some embodiments, bands or ribbons can be used in place of cables to minimize pressure points on the user.

The palm interface 112 can route the cables 106A-E from the control module 104 to the various finger interfaces 108A-D, 110, for example via a plurality of channels 136, 138, 140, 142, and 144 configured to minimize cable 106 exposure and potential pressure points on a user. In some embodiments, the channels 136, 138, 140, 142, and 144 can be constructed of a material having a low coefficient of friction to minimize frictional loss, a relatively high hardness to prevent wear, and a high degree of flexibility. For example, in one embodiment, the channels 136, 138, 140, 142, and 144 can be constructed out of polytetrafluoroethylene (PTFE). In one embodiment, the same type of material can also line the conduits 118 and anchors 120, 121 of the finger interfaces 108A-D, 110.

As depicted in FIG. 2B, a first cable 106A, which can be divided into 106A1/2, can be routed through channels 136A/B to the respective ring and pinky interfaces 108C/D for flexion control. A second cable 106B can be routed through channel 138 to the thumb interface 110 for abduction control. A third cable 106C can be routed through channel 140 to the middle finger interface 108B for flexion control. A fourth cable 106D can be routed through channel 142 to the index finger interface 108A for flexion control. A fifth cable 106E can be routed through channel 144 to the thumb interface for flexion control. Other cable configurations and routings are also contemplated.

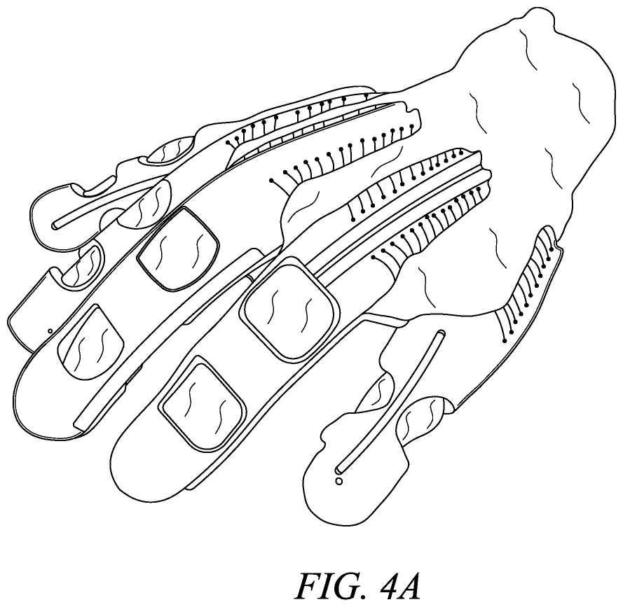

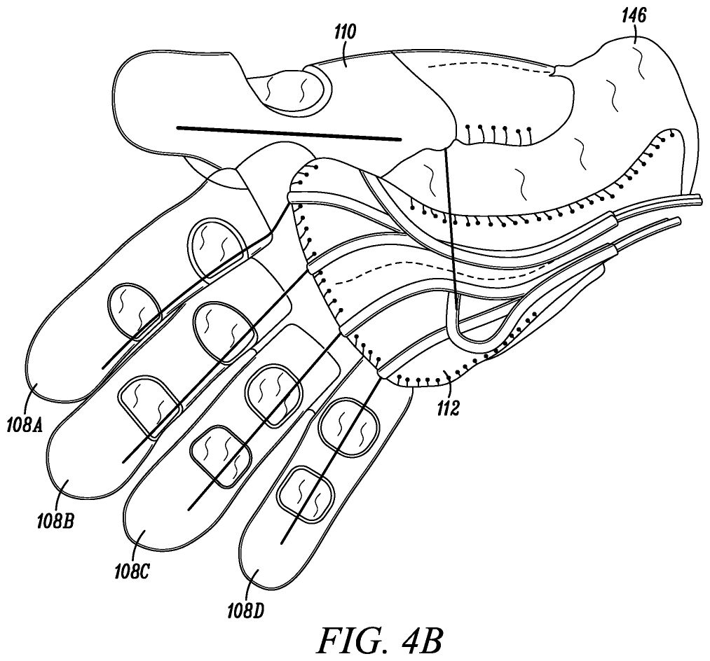

With reference to FIGS. 4A-B, in some embodiments, the individual finger and thumb interfaces 108A-D, 110 and palm interface 112 can be secured to a cloth glove 146, for example via threaded attachment points, adhesive, or the like. The cloth glove 136 can be constructed of a lightweight, comfortable material capable of dissipating heat and sweat, which is easily cleaned, easily donned and doffed, and is compatible with touchscreen devices. In some embodiments, the cloth glove 136 can be constructed of a synthetic cotton blend, such as lycra spandex. In another embodiment, the glove 136 can be constructed of a three-dimensional printed polymer. In one embodiment, the total hand interface 102 can have a weight of less than 350 g.

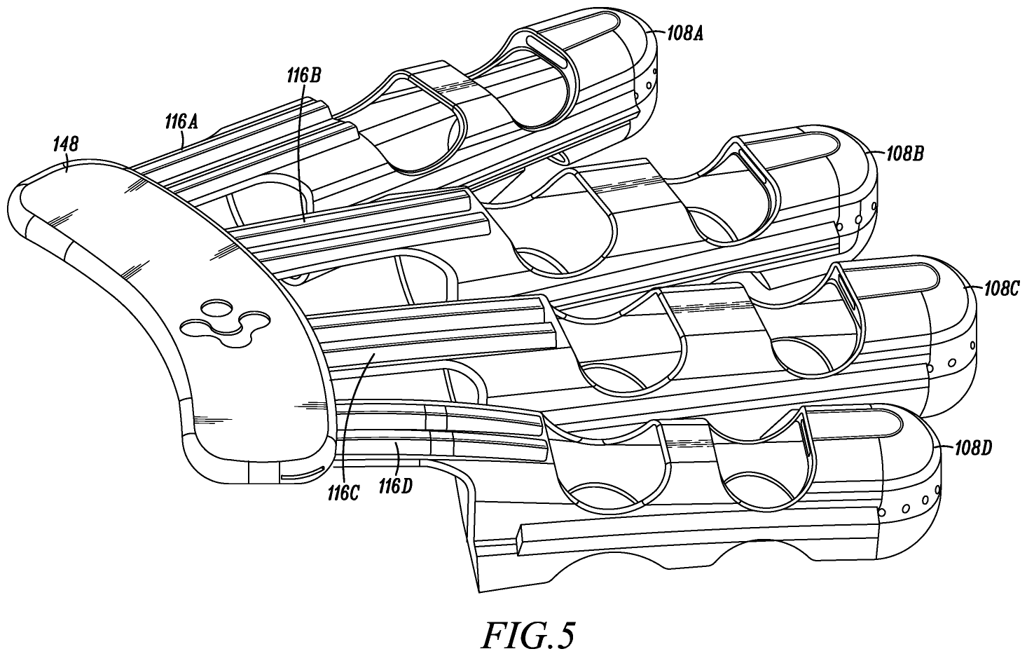

With reference to FIG. 5, in an alternative embodiment, the finger interfaces 108A-D can be operably coupled to one another via a connecting portion 148. For example, in one embodiment, the connecting portion 148 is operably coupled to the respective metacarpal extensions 116A-D; although operably contacting the various finger interfaces 108A-D at other locations is also contemplated. In some embodiments, connecting the various finger interfaces 108A-D can generally serve to improve donning and doffing of the hand interface 102, as well as further dampening spasticity present in the user.

With reference to FIGS. 6A-B, some users may have developed hypertonicity following a stroke, which frequently results in the hand being naturally biased to a clenched position. In such cases, it may be desirous to route the various cables 106 along the top of the hand interface 102, such that a force applied to the cables 106 results in extension of the various finger interfaces 108A-D, 110. Accordingly, application of a tensile force to the various cables 106 can affect an extension of the respective finger interfaces 108A-D and adduction of the thumb interface 110. A natural bias caused by the user's hypertonicity can act against the tensile forces to return the hand to the clenched position.

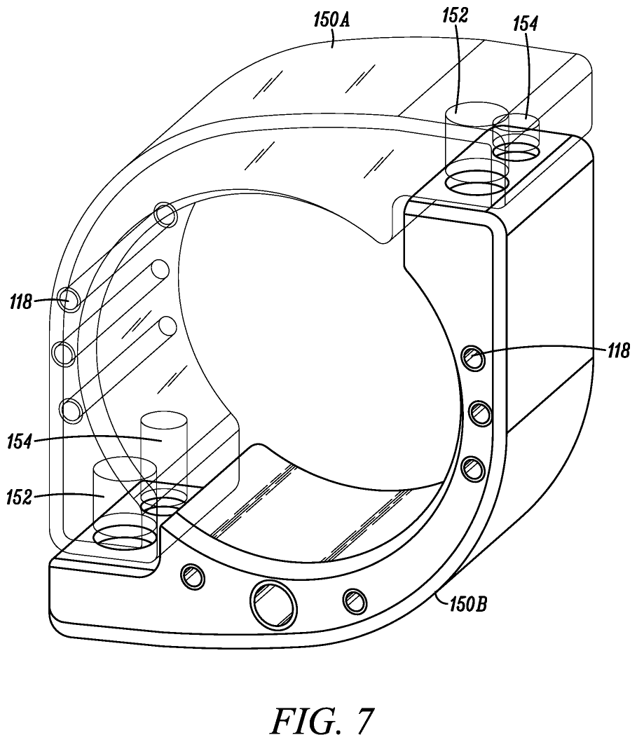

With reference to FIG. 7, in some embodiments, the individual finger interfaces 108A-D, 110 of the hand interface 102 can be configured as a two-piece clamshell having a top portion 150A and a bottom portion 150B for ease in donning and doffing the hand interface 102. In some embodiments, the two-piece clamshell configuration can be particularly useful for users with limited sensation and mobility, and high spasticity in their hand, or where otherwise threading their fingers into the hand interface 102 may be difficult. As depicted, the respective top and bottom portions 150A/B can include one or more conduits 118 through which cables 106 can be routed, and one or more embedded magnets 152 and/or alignment pins 154 configured to aid in securing the top portion 150A to the bottom portion 150B.

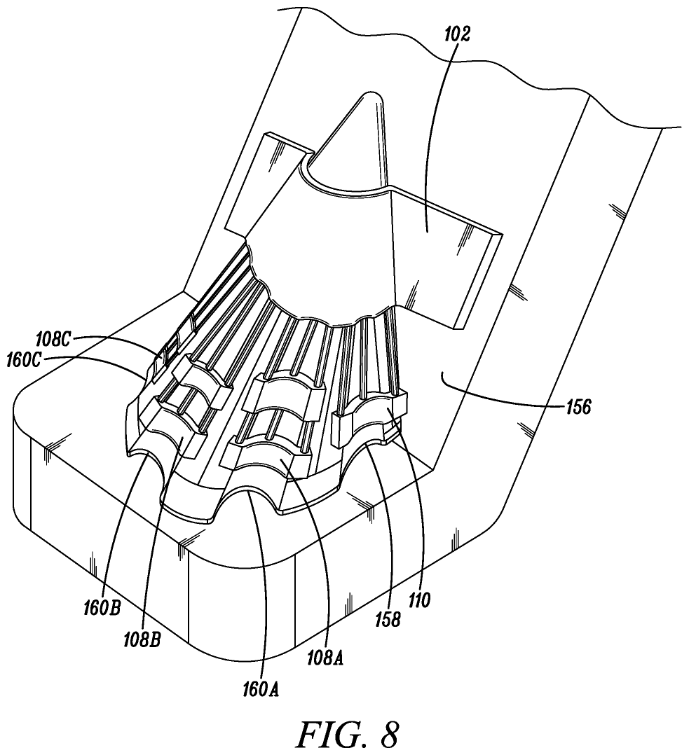

With additional reference to FIG. 8, in some embodiments, a docking station 156 can be provided as an aid in donning and doffing the hand interface 102. In one embodiment, the docking station 156 can have individual grooves 158, 160A-D configured to hold each finger interface 110, 108A-D in the open position. For example, in one embodiment, each finger interface 110, 108A-D can be held in the open position via an electromagnetic force interacting with the embedded magnets 152 (depicted in FIG. 7). When a user chooses to don the hand interface 102, the electromagnetic force can be released, and each finger interface 110, 108A-D can transition to a closed position, thereby wrapping around the user's fingers, wrist and forearm.

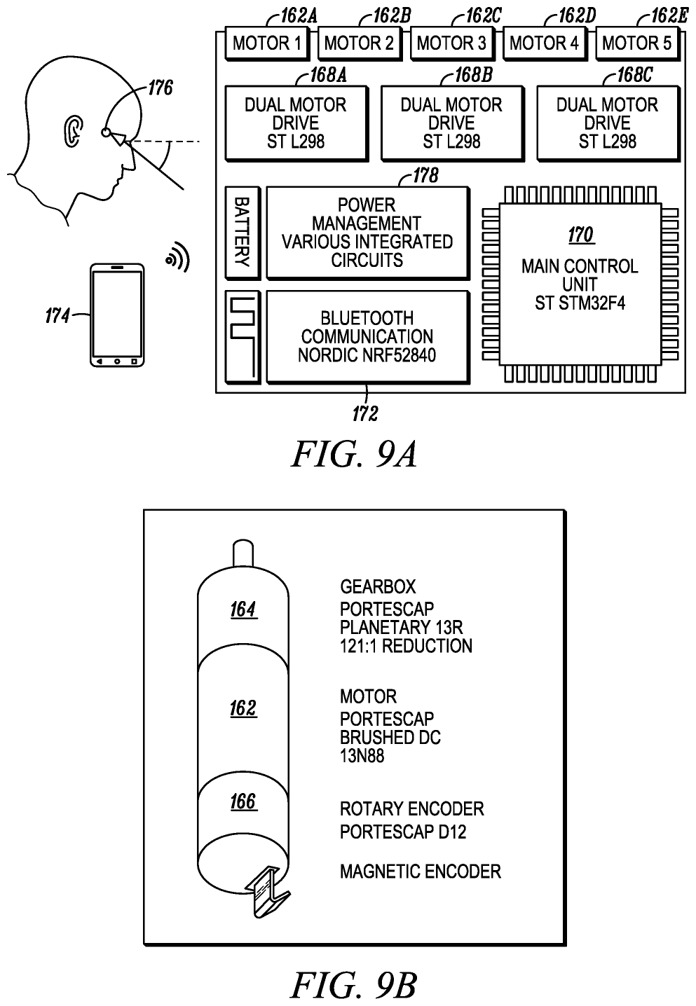

Referring to FIG. 9A, a schematic of the control module 104 is depicted in accordance with an embodiment of the disclosure. In one embodiment, the control module 104 can use five motors 162A-E to individually control the five cables 106A-E; although the use of a greater or lesser number of motors and cables is also contemplated. In some embodiments, the motors 162A-E can be selected to provide about 6.5 mNm of continuous torque, which in combination with a reduction gearbox 164 (as depicted in FIG. 9B) can produce a linear actuation force of about 180 N. In some embodiments, the upper design limit of the hand interface 102 can be a pinch force of about 30 N, and a total grip force of about 65 N, with a transition from an opened position to a closed position of less than about two seconds. Accordingly, in some embodiments, the selected motor 162 and reduction gear 164 can provide greater than two times the design limit, with the individual motors 162A-E and respective cables 106A-E oriented and positioned to ensure proper function and comfort of the user.

The control module 104 can include a distributed power system to provide automated feedback to grasp objects of various shapes and weights with grip compliance. The use of multiple motors 162A-E offers independent control of the various finger interfaces 110, 108A-D, enabling a wide variety of grip options. In some embodiments, the motors 162 can be configured to stall when they reach maximum resistance, which can depend on the electrical power supply to the motor 162. Adjustment of the electrical power supply to the motor 162 can establish the maximum resistance or grip strength. For example, in one embodiment, the control module 104 can be configured to establish a grip strength specific to the task to be accomplished (e.g., control module 104 can adjust the electrical power supply to establish a 3.4 N grip strength when handling a glass of liquid and a 0.5 N grip strength when handling keys and/or a credit card. In one embodiment, when one motor stalls the other motors can continue until they all reach the same resistance for a compliant grip.

A rotary encoder 166 (as depicted in FIG. 9B) operably coupled to each motor 162, can be configured to convert an angular position or motion of the shaft of the motor 162 to a digital output signal, thereby enabling position sensing of the various finger interfaces 108A-D, 110 during operation. Additionally, in some embodiments, an electrical supply to the motor 162 (e.g., a voltage and/or current load) can be monitored to determine a torque load of the motor 162 during operation.

With continued reference to FIG. 9A, the various motors 162A-E can be driven by a motor driver 168A-C, which can be controlled by a control unit 170, which can be in communication with a communication module 172 configured to provide wireless communication with one or more mobile computing devices 174 and one or more head orientation sensors 176. The various components of the control module 104 can be powered via a power management module 178 and a battery 180. In some embodiments, the battery 180 can be an IEC 62133 compliant lithium polymer battery configured to provide at least four hours of continual daily use.

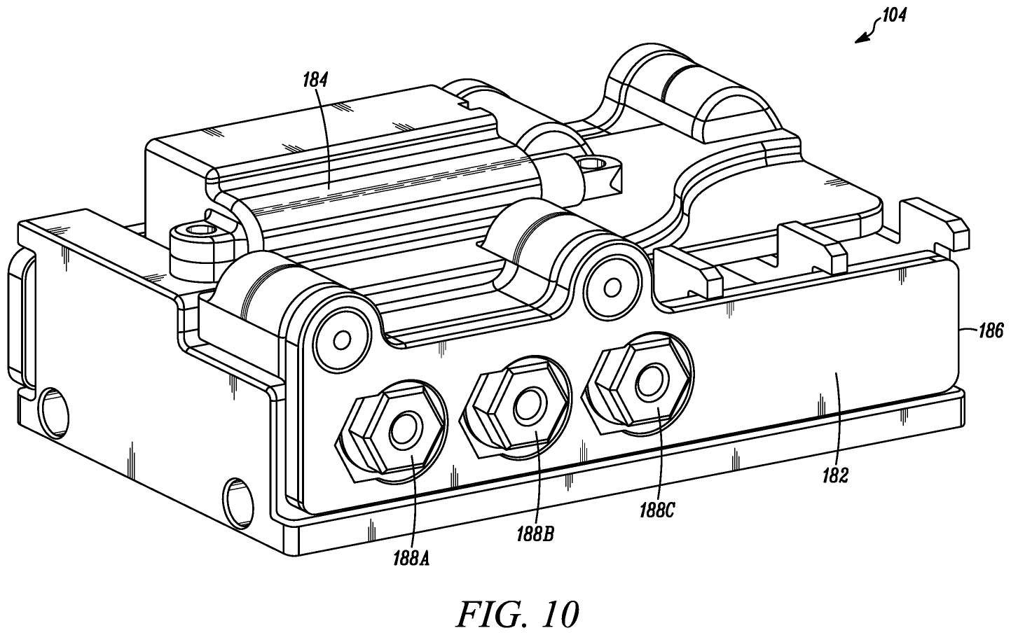

FIG. 10 depicts a perspective view of a control module 104 in accordance with an embodiment of the disclosure. In operation, the hand interface 102 may occasionally experience high loading (i.e., high force loads) during operation, for example when a user uses the orthotic 100 to transition from a sitting position to a standing position. To inhibit damage to the respective motors and/or gearboxes 162/164, in some embodiments, the control module 104 can include in isolation lock 182 configured to isolate the motors and/or gearboxes 162/164 from the high load experienced by the respective cables 106.

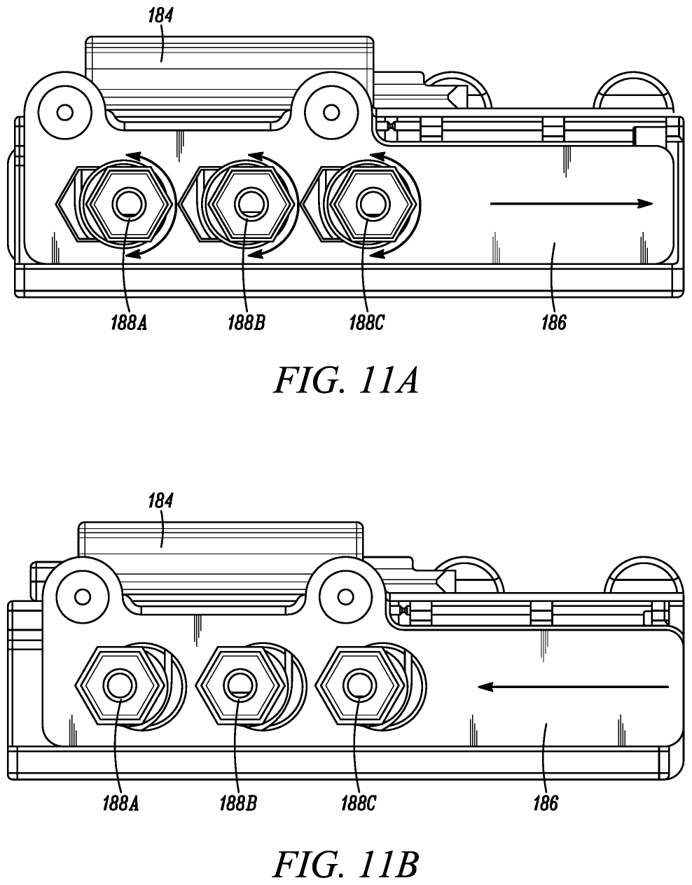

In one embodiment, the gearbox isolation lock 182 can be composed of a linear actuator 184, one or more locking slide rails 186 and a plurality of hex head pulleys 188A-C corresponding to the respective motors and/or gearboxes 162/164. The linear actuator 184 can be used to engage the locking side rails 186. As the user engages the isolation lock 182, a position control algorithm can rotate the pulleys 188 a small amount to the nearest locking configuration. The linear actuator 184 can translate the locking slide rails 188 from a operational position (as depicted in FIG. 11A) to a lockout position (as depicted in FIG. 11B). Accordingly, the slide rails 186 can be configured to inhibit rotation of respective hex head pulleys 188, thereby isolating the motors 162 and gearboxes 164 from the loads experienced by the cables 106.

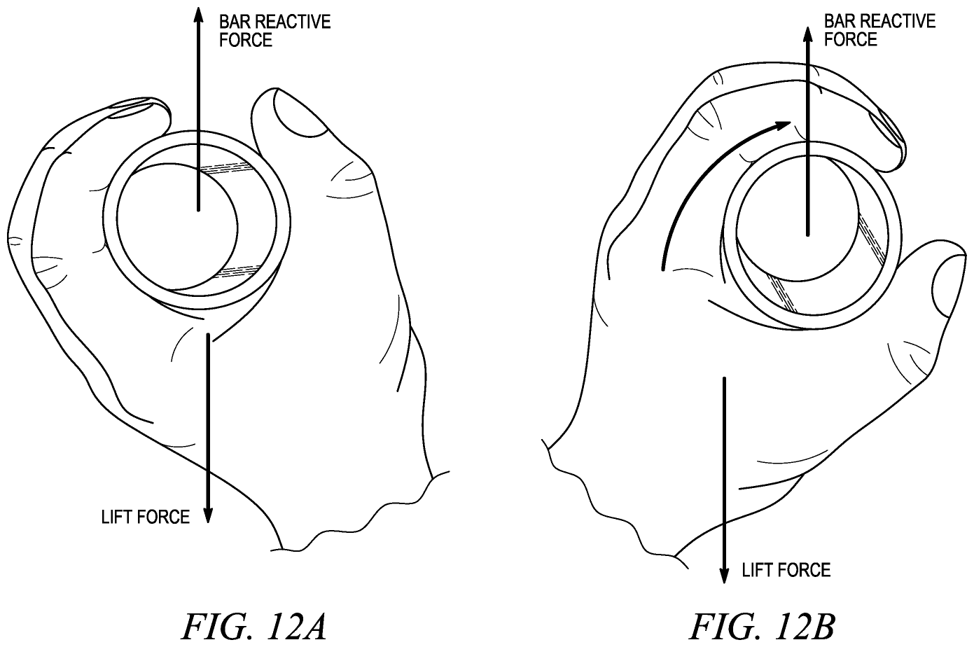

With additional reference to FIG. 12A-B, it has been recognized that it can be beneficial to affect wrist flexion during high loading, as wrist flexion can have the effect of favorably redistributing the forces within the hand interface 102. As depicted in FIG. 12A, without wrist flexion, the object being grasped tends to act as a wedge forcing the fingers and thumb of the user apart. By contrast, as depicted in FIG. 2B, with wrist flexion, the fingers of the user are generally curled over the object (such that the object no longer serves as a wedge forcing the fingers and thumb of the user apart). Accordingly, in some cases, the use of wrist flexion can generally decrease the magnitude of the grip force necessary during high loading, for example when a user uses the orthotic 100 to transition from a sitting position to a standing position. In other cases, it may be desirable to extend the wrist, for example when a user uses the orthotic 100 to push off a chair or other surface while transitioning from a sitting position to a standing position.

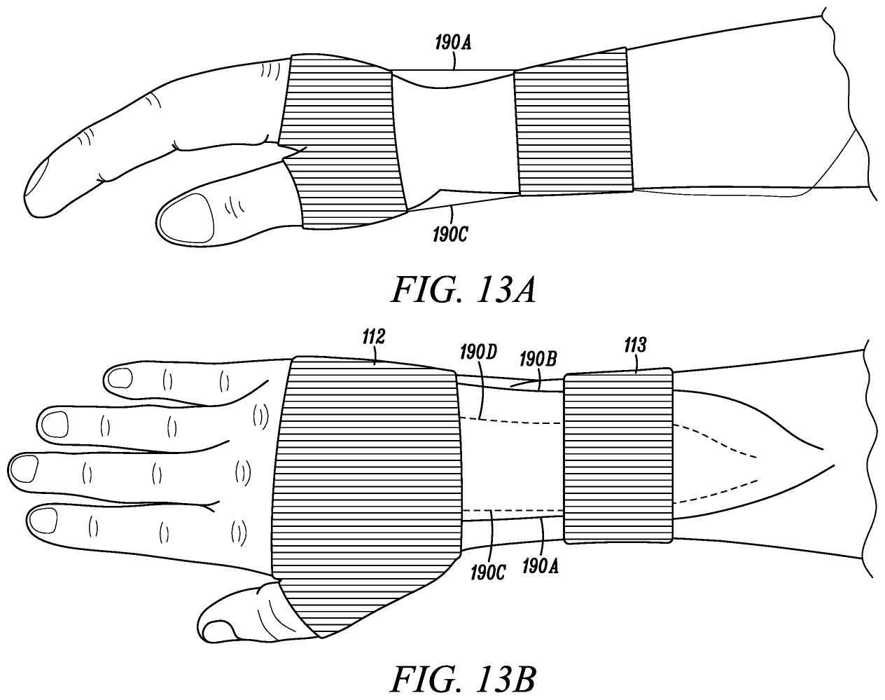

With reference to FIGS. 13A-B, in some embodiments, wrist flexion/extension, adduction/abduction and pronation/supination can be enabled through the connection of a plurality of wrist flexion cables 190 operably coupling the control module 104 to the palm interface 112, for example, via a wrist or forearm interface 113. In one embodiment, the hand orthotic 100 can include four wrist flexion cables 190A-D, thereby enabling flexion, extension, abduction, adduction, pronation, and supination. For example, in one embodiment, application of a tensile force to cables 190A/B can force wrist extension. Conversely, application of a tensile force to cables 190C/D can force wrist flexion. Likewise, application of a tensile force to cables 190A/C can force wrist abduction. Conversely, application of a tensile force to cables 190B/D can force wrist adduction. Similar manipulation of cables 190A-D can force wrist pronation and supination.

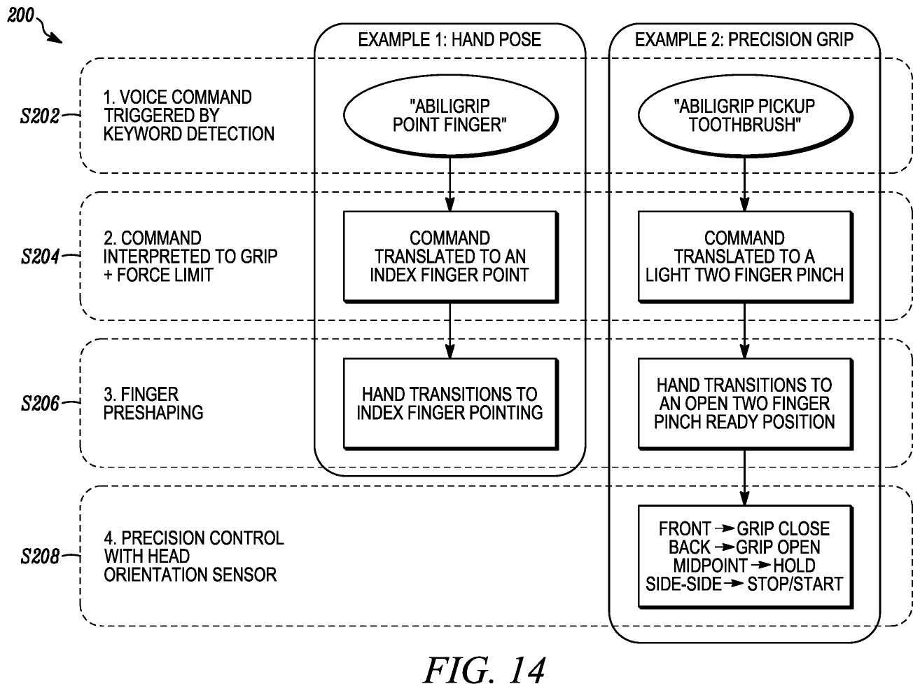

With reference to FIG. 14, a flowchart depicting a method of control 200 of the hand orthotic 100 is depicted in accordance with an embodiment of the disclosure. The control method 200 can be based on how the brain and central nervous system develop muscle coordination to accomplish specific repetitive tasks. That is, instead of the user controlling individual fingers, the user can select a hand function where the finger and thumb movements are correlated together to accomplish a specific task. These specific tasks can be accomplished for activities of daily living like grasping objects and interacting with an environment.

At S202, the user can command the hand orthotic to form a particular hand pose or desired precision grip. Individual finger control allows for automatic finger pre-shaping of a predefined grip utilizing different combinations of fingers. In one embodiment, the command can be voice-activated command, which in one embodiment can be received via a mobile computing device 174 (depicted in FIG. 9A). For example, as depicted, the user can say “Abiligrip point finger” to select the thumbs up gesture or “Abiligrip pickup toothbrush” to select a two finger pinch. In these examples, the term “Abiligrip” is referred to as a hot word signifying a particular command following the hot word; it is contemplated that other hot words can also be used. As an alternative to voice commands at S202, and one embodiment, a side-to-side head movement (as sensed by a head orientation sensor 176) can be used cycle through the various predefined hand poses and precision grips. In yet another embodiment, a camera or other sensor can sense an object to be manipulated (e.g., a glass of water, pencil, keys, etc.) and automatically form a particular hand pose to accommodate a grip of the sensed object.

At S204, the command is received and processed by the control unit 170, which in turn interprets the desired grip (e.g., finger interface position) and force limit (e.g., maximum electrical supply to the motor) for finger pre-shaping. At S206, the control unit 170 can drive the respective motors 162 until the various finger interfaces 108A-D, 110 are in their desired hand pose or precision grip positions (e.g., based on an output signal from the rotary encoder 166).

At 208, the user can use the head orientation sensor 170 to precisely open and close the grip with visual feedback. For example, in one embodiment, the control unit 170 can receive instruction from the head orientation sensor 176, thereby enabling the user to tilt their head forward to tighten the grip of the hand interface 102 around the object they wish to grip, or tilt their head backward to loosen the grip of the hand interface 102. In one embodiment, when the voice command is given at S202, the head position as noted and it becomes the midpoint for tilt sensing at S208. Thereafter, the angle of tilt of the user's head can dictate the speed of the tightening or loosening of the handgrip, thereby enabling a user to have precise control yet also quickly open or close the grip. In some embodiments, a dead zone can be established around the midpoint to prevent constant opening and closing of the grip.

It should be understood that the individual steps used in the methods of the present teachings may be performed in any order and/or simultaneously, as long as the teaching remains operable. Furthermore, it should be understood that the apparatus and methods of the present teachings can include any number, or all, of the described embodiments, as long as the teaching remains operable.

In one or more examples, the described techniques may be implemented in hardware, software, firmware, or any combination thereof. If implemented in software, the functions may be stored as one or more instructions or code on a computer-readable medium and executed by a hardware-based processing unit. Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer). Instructions may be executed by one or more processors, such as one or more digital signal processors (DSPs), general purpose microprocessors, application specific integrated circuits (ASICs), field programmable logic arrays (FPGAs), or other equivalent integrated or discreet logic circuitry. Accordingly, the term “processor” as used herein may refer to any of the foregoing structure or any other physical structure suitable for implementation of the described techniques. Also, the techniques could be fully implemented in one or more circuits or logic elements.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be used without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

What is claimed is:

1. A hand orthotic comprising:
a hand interface operably coupleable to a hand of a user, the hand interface including a thumb interface formed of a resilient material;
a control module operably coupleable to a forearm of a user, the control module including at least a first driver and a second driver; and
a plurality of cables operably coupling the hand interface to the control module, the plurality of cables including at least a first cable operably coupling the first driver to a portion of the thumb interface and a second cable operably coupling the second driver to a portion of the thumb interface, wherein the first driver is configured to provide an augmented abduction motion to the thumb interface and the second driver is configured to provide an augmented flexion motion to the thumb interface.

2. The hand orthotic of claim 1, wherein the resilient material of the thumb interface naturally biases the thumb interface against a first tensile force and a second tensile force provided by the respective first and second cables toward a neutral position.

3. The hand orthotic of claim 1, wherein the resilient material of the thumb interface is constructed of a thermoplastic elastomer.

4. The hand orthotic of claim 2, wherein the thumb interface further includes at least one resilient stiffening member configured to bias the thumb interface against at least one of the first tensile force or second tensile force toward the neutral position.

5. The hand orthotic of claim 1, wherein the thumb interface includes a sleeve portion configured to at least partially fit over a thumb of a user, and a metacarpal extension portion operably coupled to the sleeve portion and configured to reside in proximity to a metacarpal bone of a user.

6. The hand orthotic of claim 5, wherein the sleeve portion includes structure defining a first cutout in proximity to a distal interphalangeal joint of a user and a second cutout in proximity to a proximal interphalangeal joint of the user, thereby promoting ease in bending of the sleeve in proximity to first and second cutout.

7. The hand orthotic of claim 1, wherein the hand interface further includes a plurality of finger interfaces.

8. The hand orthotic of claim 1, wherein the hand interface is customizable to meet the size and assistant needs of a user.

9. The hand orthotic of claim 1, wherein the thumb interface includes a top portion and a bottom portion configured to selectively couple to one another during donning and doffing of the hand interface.

10. A hand orthotic comprising:
a hand interface; and
a control module including a plurality of motors and corresponding gearboxes operably coupled to the hand interface via a plurality of cables, the control module further including a gearbox isolation lock configured to selectively shift between a rotation position enabling rotation of the respective plurality of motors and corresponding gearboxes, and a lockout position configured to at least partially isolate the plurality of motors and corresponding gearboxes from loads experienced by the plurality of cables.

11. The hand orthotic of claim 10, wherein the hand interface includes a plurality of finger interfaces operably coupleable to fingers of a user.

12. The hand orthotic of claim 11, wherein each of the plurality of finger interfaces includes a sleeve portion configured to at least partially fit over a finger of a user, and a metacarpal extension operably coupled to the sleeve portion and configured to reside in proximity to a metacarpal bone of a user.

13. The hand orthotic of claim 11, each of the plurality of finger interfaces includes structure defining a first cutout in proximity to a distal interphalangeal joint of a user and a second cutout in proximity to a proximal interphalangeal joint of the user, thereby promoting ease in bending of the finger interfaces in proximity to first and second cutout.

14. The hand orthotic of claim 11, wherein each of the plurality of finger interfaces includes a top portion and a bottom portion configured to selectively couple to one another during donning and doffing of the hand interface.

15. The hand orthotic of claim 10, wherein hand interface is constructed of a resilient material configured to naturally biases a respective plurality of finger interfaces against tensile forces provided by the respective plurality of cables toward a neutral position.

16. The hand orthotic of claim 15, wherein the resilient material of the hand interface is constructed of a thermoplastic elastomer.

17. The hand orthotic of claim 10, wherein the hand interface includes one or more resilient stiffening member configured to bias a respective finger interface against a tensile force provided by one of the plurality of cables toward a neutral position.

18. A method of controlling a hand orthotic, comprising:
receiving a hand interface pre-shaping command;
controlling a plurality of drivers to drive individual finger interfaces of a hand interface to predetermined positions according to the pre-shaping command; and
activating a head worn orientation sensor to receive one or more grip commands.

19. The method of claim 18, wherein the hand interface pre-shaping command is received as a voice command signal.

20. The method of claim 18, wherein a forward tilt of the head worn orientation sensor is received as a first grip command to tighten a grip of the hand interface, and a rearward tilt of the head worn sensor is received as a second grip command to loosen a grip of the hand interface.
